(19) United States
(12) Patent Application Publication
(10) Pub. No.: US 2013/0327462 A1
(43) Pub. Date: Dec. 12, 2013

(54) SYSTEM AND METHOD FOR FORMING LAMINATED MATERIALS FOR MATTRESSES

(71) Applicant: Atlanta Attachment Company, Lawrenceville, GA (US)

(72) Inventor: Elvin C. Price, Dacula, GA (US)

(21) Appl. No.: 13/916,061

(22) Filed: Jun. 12, 2013

Related U.S. Application Data
(60) Provisional application No. 61/658,609, filed on Jun. 12, 2012.

(51) Int. Cl. B32B 37/10; B32B 37/00

(52) U.S. Cl. CPC B32B 37/10; B32B 37/0046
USPC 156/60; 156/556

(57) ABSTRACT

A laminating system and method for forming laminated bedding materials such as for mattress borders or other bedding components. The laminating system includes a frame on which a series of supply rolls of different bedding material are supported. An adhesive is applied between the bedding material layers, after which the bedding material layers are fed into registration with each other. The side edges of the bedding material layers can then be serged to seal their side edges, and the bedding material layers passed through compression rollers to press and laminate the bedding material layers together in tight adhesive contact.

### CROSS REFERENCE TO RELATED APPLICATION

The present Patent Application is a formalization of previously filed, co-pending U.S. Provisional Patent Application Ser. No. 61/658,609, filed Jun. 12, 2012 by the inventor named in the present Application. This Patent Application claims the benefit of the filing date of this cited Provisional Patent Application according to the statutes and rules governing provisional patent applications, particularly 35 U.S.C. §119(a)(i) and 37 C.F.R. §1.78(a)(4) and (a)(5). The specification and drawings of the Provisional Patent Application referenced above are specifically incorporated herein by reference as if set forth in their entirety.

### FIELD OF THE INVENTION

The present invention generally relates to the production of mattresses and other bedding components, and in particular to the production of laminated fabric materials for use in the construction of mattresses and other bedding components.

### BACKGROUND OF THE INVENTION

In the past, the formation of covering materials used for various components of mattresses, box springs or other bedding articles have been made together, with the tops and borders of the mattresses generally being cut from rolls of a similar material. For example, many companies have formed the materials used for the borders of their mattresses or other bedding articles by running a length of full mill width quilted material such as typically used for the mattress tops, and then slitting and/or cutting such quilted material into sections of a desired width as needed for forming a border for different thickness mattresses. Thereafter, such slit or cut quilted materials generally would be fed through a separate sewing system so as to serge and lock the edges of the border material together and/or apply a flanging material thereto to complete the formation of the borders. However, since the borders generally form the vertical sides of a mattress or other bedding article and typically have minimal contact with the consumer, many companies view it as a waste to form such border materials out of expensive quilted materials, which often include multiple layers of foam, filler and/or backing materials that are sewn to a ticking material with a quilted pattern. In addition to the more expensive material cost associated with using such quilted materials, which generally are not needed for the borders, and additional sewing/finishing operations, there is often an additional expense in setting up or operating such quilting machines to form borders, which at the same time can take the quilting machine out of operation for forming mattress tops or other components of the mattresses.

As an alternative to quilted border materials, many companies are now turning to the use of laminated border materials wherein a fabric ticking is attached to a flame retardant fiber material and a backing material by adhesives to form a laminated border structure. Typically, a powdered or hot melt adhesive material will be applied between the ticking and flame retardant fiber layers, as well as between the flame retardant fiber layer and backing, after which the border materials are passed over a heated roll that heats the adhesive to its melting point, following which the materials are compressed together by laminating or compression rolls to form the laminated border material. While material costs for such laminated border materials can be less, such operations generally must be done by third parties due to the expense and size constraints of the specialty equipment required for the laminating processes. In addition, such conventional laminating systems and processes typically operate at a somewhat slow rate of approximately up to fifteen feet or less per minute and after the laminated materials are finished, they still must be shipped in rolls to the mattress/bedding manufacturer, which adds to the cost thereof. Such laminated material rolls further generally are formed as full mill width laminated materials, and it is then left to the mattress/bedding manufacturer to slit or cut borders at desired widths from the mill width roll of materials, and thereafter serge and trim the edges thereof to finish the borders. The necessity of using third parties for the manufacture of such laminated border materials generally requires the bedding manufacturers maintain a supply of laminated material rolls in inventory to form these borders. This further hampers companies' abilities to manufacture borders with a desired appearance or style as needed in a just-in-time type manufacturing process for more efficiently forming mattresses with a consistent look and/or appearance.

Accordingly, it can be seen that a need exists for a system and method of forming laminated mattress materials such as for borders and other mattress components, which addresses the foregoing and other related and unrelated problems in the art.

### BRIEF DESCRIPTION OF THE DRAWINGS

FIG. 1 is a perspective view of a first embodiment of the system and method for forming laminated bedding materials in which the system is arranged in a longitudinal, inline arrangement.

FIG. 2 is a perspective illustration of another embodiment of the system and method for forming laminated bedding materials according the principles of the present invention, in which the bedding material is fed along a shortened, reversing path of travel to provide for a more compact and floor space saving arrangement of the system.

FIG. 3A is a perspective illustration of an example of laminated bedding materials formed using the system and method according to the principles of the present invention.

FIG. 3B is an exploded perspective view illustrating the application of adhesive materials between the layers of the laminated bedding materials.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION OF THE INVENTION

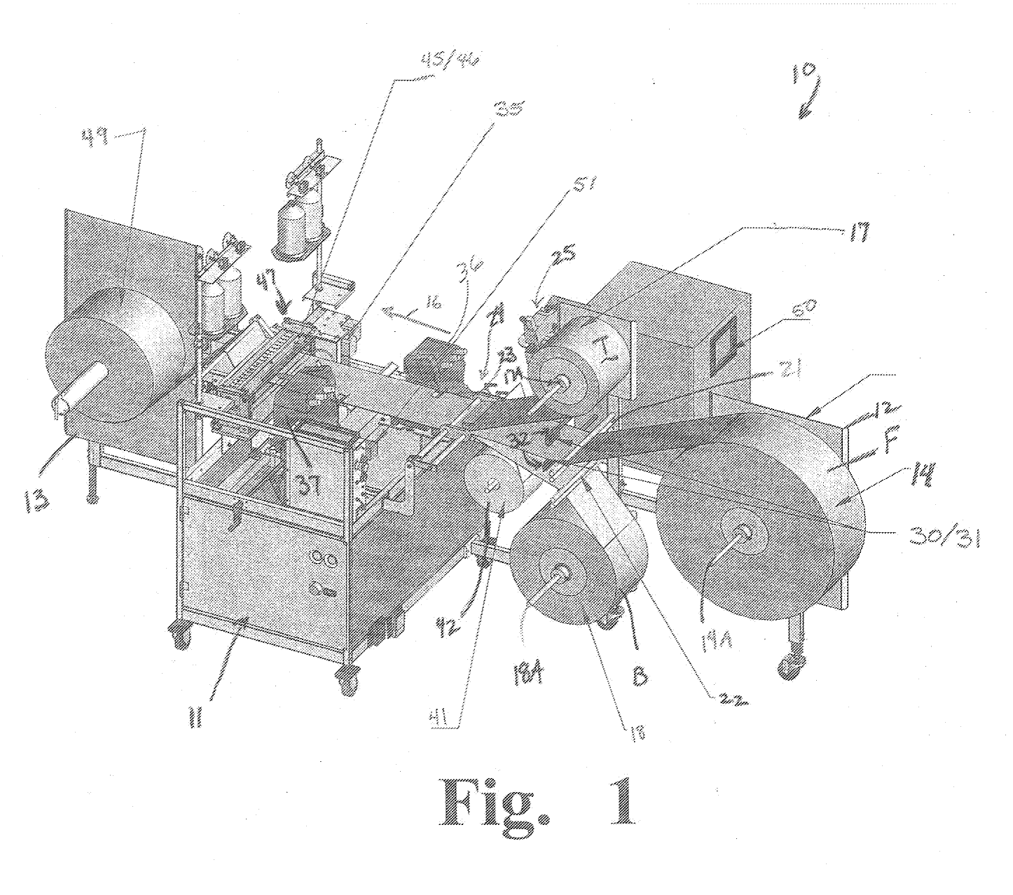

Referring now to the drawings in which like numerals indicate like parts throughout the several views, FIGS. 1-3B generally illustrate example systems and methods of forming a laminated bedding material M such as for use in forming borders and other, similar components for mattresses, box springs and other bedding components. As indicated in the figures, the laminated material M generally can include at least two or more bedding material layers that can be pre-cut to or ordered with a correct border width or size, such that additional processing of such layers, such as slitting desired width layers from a larger, full or mill width roll of such materials is not necessary with the present invention.

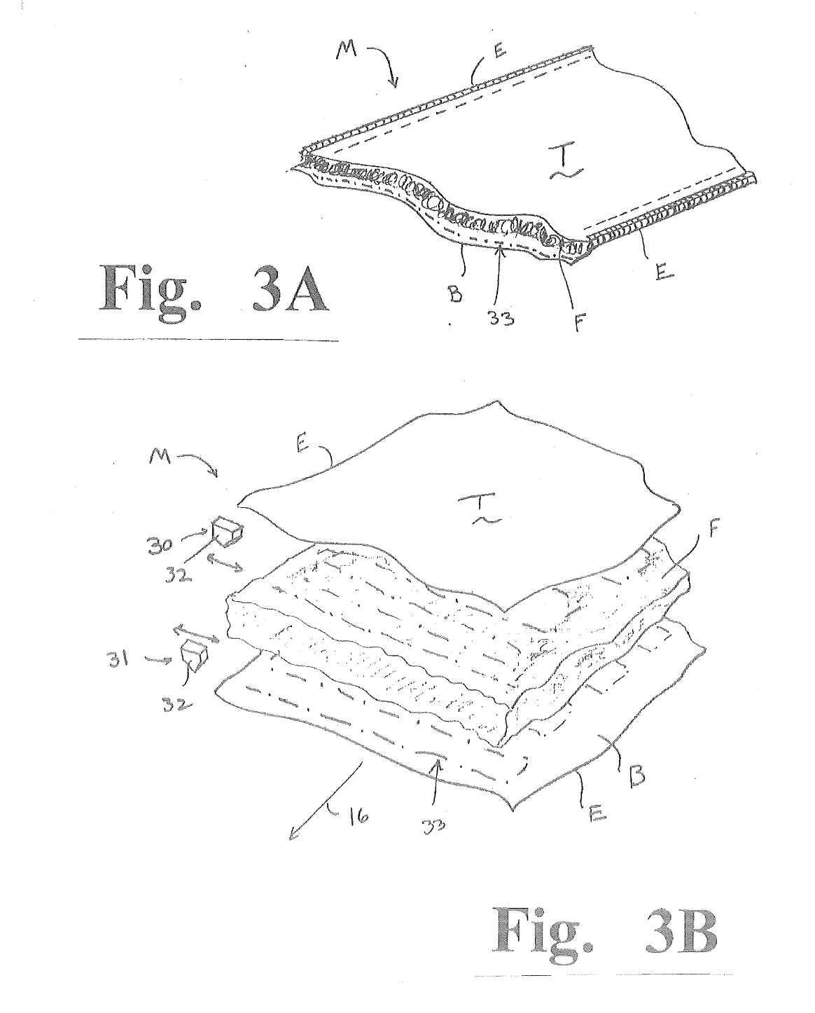

The bedding material layers typically will include a first, upper layer of a ticking material T which generally can be formed with a decorative appearance or can be formed with various shades or colors and which will be the bedding material layer viewed from the outside of the mattress. A second bedding material layer of a fibrous flame retardant filler material F, as required by and in accordance with State and Federal safety and fire codes applicable to bedding materials, will be applied to a rear surface of the ticking material T, and thereafter, a third bedding material layer of a backing B also can be applied to the flame retardant material F, opposite the ticking, as needed. The entire structure of the ticking material overlaid over the flame retardant filler material and backing material generally will be laminated together and the side edges E thereof serged and sewn together such as with overlock stitching, as indicated in FIG. 3A, and with the bedding material layers being adhered together with a pressure sensitive adhesive, in order to form the completed laminated material M as illustrated in FIG. 3A.

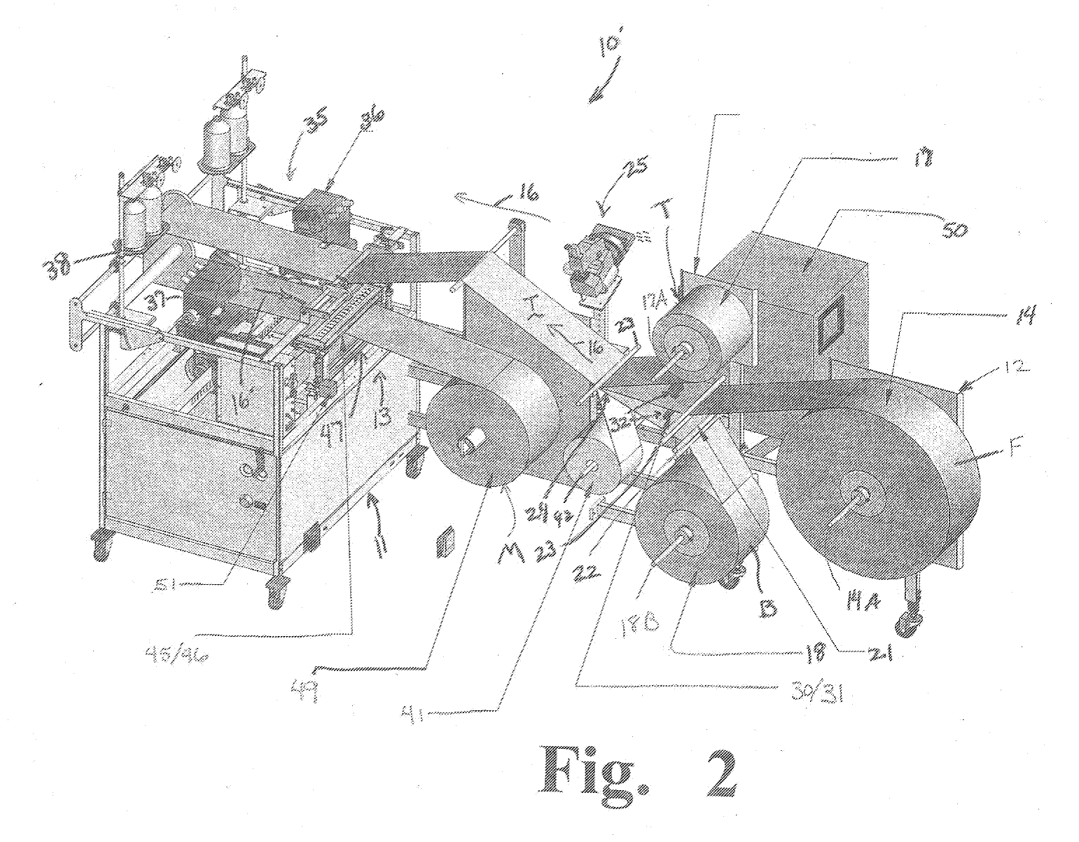

FIGS. 1 and 2 generally illustrate two alternative example embodiments 10 and 10′ of the laminating system for forming laminated bedding materials M according to the principles of the present invention. As illustrated in FIGS. 1 and 2, the laminating system 10/10′ generally will include an elongated frame 11 having a first or upstream or inlet end 12 and a second, downstream or outlet end 13. In both of the illustrated embodiments, a filler roll 14 generally will be mounted at the upstream or inlet end of the frame, typically being mounted on a spindle 14A or similar mounting mechanism to enable the filler roll, which contains the flame retardant material F, to rotate so as to feed the flame retardant material F along a sewing path, indicated at 16, through the laminating system 10/10′. Downstream from the filler roll are a tick roll 17 of the ticking material T and a backing roll 18 of the backing material B, each being rotatably supported on a spindle 17A/18A to enable rotation of the tick and backing rolls for feeding the ticking material T and backing material B along the sewing path 16 and into registration with the filler roll.

As illustrated in FIGS. 1 and 2, sets of guide rods 21, 22 and 23 are positioned at varying locations along the sewing path. The guide rods 21 engage and redirect the flame retardant filler material toward guide rods 23, while guide rods 22 redirect the backing material B and guide it towards guide rods 23 whereupon the three materials are brought into registration and engagement with one another, as indicated at 24. In addition, the filler roll, tick roll and backing roll each will generally include a material roll out detector, such as a photocell, proximity sensor, load cell or other, similar sensing mechanism, that detects when the level of material thereon has reached a desired notification point whereupon the system will signal an operator that the material is about to run out to enable replacement thereof.

A movable splicing sewing head 25 further is illustrated in FIGS. 1 and 2 as being upstream from the tick roll, and typically will be located adjacent the tick roll as shown in FIG. 1, although the sewing head 25 further could be movable to other locations or positions along sewing path 16 as needed. The splicing sewing head generally can be a single needle sewing head or similar mechanism that can be used to sew the trailing end of a finished roll of the ticking material to the leading end of a new roll of ticking material. The flame retardant filler material and backing material can be similarly joined, if needed, but typically these materials can be simply overlapped and fed through the laminating system without necessarily having to join the trailing end of a finished toll to the leading end of a new or replacement roll of such materials.

Adhesive applicators 30 and 31 generally will be mounted upstream from the guide rod 23 adjacent the point 24 at which the ticking material T, flame retardant filler material F and backing material B are brought into registration with one another. Adhesive applicator 30 generally will be mounted between the flame retardant filler material and ticking material, while adhesive applicator 31 generally will be mounted between the backing material and flame retardant filler material as indicated in FIGS. 1, 2 and 3B. Each of the adhesive applicators generally will include an applicator head 32 having one or more spray nozzles affixed therealong. The applicator heads 32 generally can be movable along a desired path of travel, such as indicated in FIG. 3B, transversely back and forth across the sewing path 16 for application of an adhesive material between the ticking, flame retardant filler and backing materials.

As FIG. 3B further illustrates, the adhesive material can be applied in discrete or desired patterns 33, such as in lines or dots at spaced intervals across the width of the ticking, flame retardant filler and/or backing materials, or can be applied in a substantially continuous film or other application. The adhesive material generally will be applied in a liquid form, typically including an atomized hot melt adhesive, pressure sensitive adhesive or water-based glue, or other similar adhesive materials that can be sprayed onto the ticking, flame retardant filler and/or backing materials in a controlled fashion. Alternatively, the adhesive applicators could be provided with extrusion heads that will extrude or apply a substantially solid or gel-based glue or other adhesive materials between the laminated material layers, as will be understood by those skilled in the art.

The travel of the applicator heads 32 of the adhesive applicators 30 and 31 generally will be controlled in accordance with the width of the ticking, flame retardant filler and/or backing materials to ensure that a sufficient amount of adhesive is applied to these materials to adhere them together upon lamination, but without applying excess material that would seep or be otherwise forced to the edges of the laminated materials and potentially disrupt or create an issue with the downstream serging of the side edges of the laminated material. The movement of the applicator heads can be controlled by various means, including limit switches, sensors or a physical/manual hard stop that can be set and/or programmed by the operator based upon the width of the ticking, flame retardant filler and/or backing materials so that the travel of the adhesive applicators will be limited to only a certain area or portion of the width of these materials. Alternatively, the adhesive applicators can be fixed or otherwise remain stationary and can be provided with a series of adjustable nozzles that can be activated or deactivated as needed to apply a controlled volume of adhesive material between the layers of the laminated material M. Still further, only one adhesive applicator could be used, if needed, depending upon the thickness of the fibers of the flame retardant filler material, which could enable a portion of the adhesive material to pass therethrough and thus engage the backing material. As another alternative, in systems where a backing material is not required, only one adhesive applicator likewise may be used, even though two adhesive applicators can be provided with the lower adhesive applicator 31 simply being controlled or otherwise shut off.

As the ticking material T, flame retardant filler material F and backing material B, with the adhesive applied thereto, continue downstream, they generally will pass through or be engaged by downstream guide rods 23, which tend to urge the adhesive coated materials into registration with one another. Thereafter, the adhesive coated layers of the laminated material M pass into a sewing zone 35 in which the side edges E of the laminated material M will be engaged, trimmed and sewn by a pair of serging heads 36 and 37. Typically, one of the serging heads 36 will be mounted slightly upstream from the second serging head 37 so that the side edges of the laminated material M are engaged and trimmed and sewn at different times in order to seal the edges of the laminated material. In FIG. 1, the serging heads 36 and 37 are shown as being mounted along the sewing path 16 on opposite sides thereof at a longitudinally staggered interval, in a single lane processing design or configuration.

Alternatively, in the embodiment of the laminating system 10′ shown in FIG. 2, the sewing path can be reversed on itself, with the material passing about a guide or roller 38 and being redirected along a lower or return side 16′ of the sewing path 16. In such an embodiment, serging head 36 generally can be positioned along the upper side of the sewing path 16, while serging head 37 can be positioned along the lower or return side of the sewing path. Such a construction in which the sewing path reverses on itself can be used to provide a smaller footprint or reduced or more compact construction for the laminating system. Each of the serging heads generally will include overlock serging heads or similar serging/sewing mechanisms as will be understood by those skilled in the art, and will generally trim and sew the side edges of the laminated material with an overlock or similar stitching to substantially seal the side edges thereof.

As additionally shown in FIGS. 1 and 2, an optional flanging roll 41 containing a flanging material 42 can be mounted just below the registration point 24 at which the ticking material T, flame retardant filler material F and backing material B are brought together. The flanging material can be carried with the layers of the laminated material M into the downstream sewing zone 35 and will be attached along one side, i.e., by serging head 36, of the laminated material at the same time as the serging of that side edge of the laminated material.

After the side edges of the laminated material have been sewn together, the laminated material then will be passed through a pair of compression rolls or nip rolls, indicated at 45 and 46, as part of a laminating station or zone 47. The compression rolls will urge the layers of the laminated material together, compressing them into a sealed adhesive contact. Thereafter, the laminated material will be fed and wound up about a rewind roll 49 for storage.

The laminating systems 10/10′ according to the principles of the present invention can accommodate varying width or size borders as needed to form different mattresses of various thicknesses. The application of the adhesive materials can be controlled via a computer control system 50 to apply a desired amount of adhesive as needed to achieve a desired seal or lamination between the material layers, with the path of travel and/or the amount of adhesive being applied being controlled both in terms of the volume of adhesive applied as well as the area across which the adhesive is applied. The position of the compression rolls further can be adjusted as needed, such as by an automatic or manually engageable width control 51, to accommodate the varying widths and to control the movement of the laminated materials along the sewing path to ensure consistent feeding.

As a result, with the system and method for laminating bedding materials according to the principles of the present invention, laminated bedding materials can be manufactured at increased rates of up to 80 to 100 feet per minute, increasing the manufacturing capability for the manufacture of such laminated bedding materials, while at the same time enabling a manufacturer to manufacture borders and other bedding materials having a desired appearance as needed in a “just-in-time” type manufacturing.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

1. A system for laminating mattress components comprising:
a frame;
a supply of a first bedding material mounted on the frame and fed along a path of travel;
a supply of a second bedding material mounted on the frame and fed toward a point where the second bedding material is brought into registration and engagement with the first bedding material being fed along its path of travel;
at least one adhesive applicator upstream from the point where the second bedding material is brought into registration and engagement with the first bedding material for applying an adhesive material between the first and second bedding materials prior to the first and second bedding materials being brought into registration; and
a series of rollers located downstream from the point where the second bedding material is brought into registration and engagement with the first bedding material, wherein the first and second bedding materials are passed between the rollers and compressed so as to bond the bedding materials together in a laminated structure.

2. The system of claim 1 and further comprising at least a first sewing station for serging at least one side edge of the first and second bedding materials together after the first and second bedding materials have been brought into registration.

3. The system of claim 2 and further comprising a second sewing station arranged adjacent the first sewing station on an opposite side of the path of travel of the first and second bedding materials for serging another side edge of the first and second bedding materials.

4. The system of claim 2 and further comprising a second sewing station arranged along a reverse side of the path of travel of the first and second bedding materials for serging another side edge of the bedding materials.

5. A method of forming laminated bedding materials, comprising:
moving a first bedding material layer along a path of travel;
moving a second bedding material layer along a path of travel and toward registration with the first bedding material layer;
applying an adhesive material to at least one of the first and second bedding material layers prior to the first and second bedding material layers moving inₜo registration; and
pressing the bedding material layers together to bond the bedding material layers into a laminated structure.

6. The method of claim 5, further comprising attaching at least one side edge of the bedding material layers together after the bedding material layers have been brought into registration.

7. The method of claim 5, wherein the bedding materials are brought into registration and are laminated together along a single, converging path of travel.

8. The method of claim 7, further comprising engaging and sewing opposite side edges of the bedding material layers to attach the bedding material layers together along their side edges prior to pressing the bedding material layers together.

9. The method of claim 8, wherein engaging and sewing opposite side edges of the bedding material layers comprises moving the opposite side edges of the bedding material layers through sewing heads arranged along opposite sides of the converging path of travel of the bedding material layers.

10. The method of claim 8, wherein engaging and sewing opposite side edges comprises sewing a first side edge of the bedding material layers along a first portion of their converging path of travel, inverting the bedding material layers and sewing a second side edge of the bedding material layers.

11. The method of claim 5, wherein applying an adhesive material comprises moving at least one adhesive applicator head transversely with respect to at least one of the path of travel of the first bedding layer or the path of travel of the second bedding layer to apply the adhesive material between the first and second bedding layers.

12. The method of claim 11, wherein the at least one adhesive applicator head applies the adhesive material by spraying or extruding the adhesive material between the first and second bedding material layers.

13. The method of claim 5, wherein applying an adhesive material comprises moving an adhesive applicator head transversely across the path of travel of the first bedding material layer and across the path of travel of the second bedding material layer for applying the adhesive material to a surface of each of the first and second bedding material layers.

14. A system for forming laminated fabric materials, comprising:
a series of material rolls each feeding a material layer toward registration along a path of travel;
at least one adhesive applicator located along the path of travel of the material layers fed from the supply rolls for applying an adhesive material between at least selected ones of the material layers; and
a sewing zone downstream from a point at which the material layers are fed into registration, with at least one sewing machine located along the sewing zone for engaging and attaching side edges of the material layers.

15. The system of claim 14, wherein the sewing zone comprises a second sewing station arranged adjacent the first sewing station on an opposite side of the path of travel of the first and second bedding materials for serging another side edge of the first and second bedding materials.

16. The system of claim 14, further comprising a second sewing station arranged along a reverse side of the path of travel of the first and second bedding materials for serging another side edge of the bedding materials.

17. The system of claim 14, further comprising a laminating station downstream from the sewing zone, for engaging and pressing the material layers into a laminated material.

18. The system of claim 14, wherein the at least one adhesive applicator comprises a movable adhesive head that is movable between the at least two material layers and in a direction transverse to the path of travel of the material layers and which applies an adhesive material in a desired pattern to at least one of the material layers.

19. The system of claim 14, wherein the series of material rolls comprises a roll of backing material, a roll of filler, and a roll of ticking material.

20. The system of claim 19, wherein the at least one adhesive applicator comprises a series of adhesive heads each movable between two of the material layers and in a direction transverse to the path of travel of the material layers for applying an adhesive material in a desired pattern to at least one of the material layers.

21. The system of claim 14, further comprising a roll of flanging material.

22. The system of claim 14, further comprising material run-out detectors on at least selected ones of the material rolls.
